(19) United States
(12) Patent Application Publication
(10) Pub. No.: US 2025/0039937 A1
(43) Pub. Date: Jan. 30, 2025

(54) RADIO NETWORK NODE, USER EQUIPMENT AND METHODS PERFORMED THEREIN

(71) Applicant: Telefonaktiebolaget LM Ericsson (publ), Stockholm (SE)

(72) Inventors: Jan CHRISTOFFERSSON, Luleå (SE); Min WANG, Luleå (SE); Mårten ERICSON, Gammelstad (SE); Stefan WÄNSTEDT, Luleå (SE)

(21) Appl. No.: 18/715,722

(22) PCT Filed: Dec. 3, 2021
(86) PCT No.: PCT/SE2021/051198

§ 371 Date: Jun. 2, 2024

(51) Int. Cl. H04W 74/0833; H04W 24/10

(52) U.S. Cl. CPC H04W 74/0833; H04W 24/10

(57) ABSTRACT

Embodiments herein relate to, for example, a method performed by a coordinating UE for handling a cooperative transmission of data from a group of UEs in a wireless communications network. The coordinating UE obtains one or more indications from one or more UEs of the group of UEs, wherein each indication indicates a preferred synchronization signal block, SSB, for respective UE. The coordinating selects an SSB for a random access procedure for the group of UEs performing the cooperative transmission based on the obtained one or more indications, and transmits an SSB indication to the group of UEs indicating the selected SSB. The UE then performs the random access procedure to a radio network node based on the selected SSB.

### TECHNICAL FIELD

Embodiments herein relate to a radio network node, user equipment (UE) and methods performed therein regarding wireless communication. Furthermore, a computer program product and a computer-readable storage medium are also provided herein. In particular, embodiments herein relate to handling communication, such as handling cooperative transmissions from a group of UEs, in a wireless communications network.

### BACKGROUND

In a typical wireless communications network, user equipment (UE), also known as wireless communication devices, mobile stations, stations (STA) and/or wireless devices, communicate via a Radio Access Network (RAN) with one or more core networks (CN). The RAN covers a geographical area which is divided into service areas or cells, with each service area or cell being served by a radio network node such as an access node e.g. a Wi-Fi access point or a radio base station (RBS), which in some networks may also be called, for example, a NodeB, a gNodeB, or an eNodeB. The service area or cell is a geographical area where radio coverage is provided by the radio network node. The radio network node operates on radio frequencies to communicate over an air interface with the UEs within range of the radio network node. The radio network node communicates over a downlink (DL) to the UE and the UE communicates over an uplink (UL) to the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and investigate e.g. enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and coming 3GPP releases, such as New Radio (NR), are worked on. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the emerging 5G technologies such as new radio (NR), the use of very many transmit- and receive-antenna elements may be of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

Herein it is described cooperative transmissions, sidelink in NR as well as 4-step random access (RA) and 2-step RA in NR release 15 and release 16, respectively.

### Cooperative Transmissions.

Device to device (D2D) group communication may be a way to increase the uplink coverage and user bit rate, for example, in a future high frequency 5G network. On a high level, a group of UEs, such as sensors or internet of things (IoT) capable devices, are D2D capable, and when a UE has data to transmit it will first distribute this data to neighboring UEs in the group over the D2D or sidelink (SL) connection. In a second step, the UEs in the group will cooperatively transmit the data over the cellular UL. The cooperative transmission will increase the UL coverage, e.g., by combining several UEs the total output power and may be beneficial from a latency point of view compared to repeated transmissions for coverage, as used, e.g., in LTE narrowband (NB-IoT). A D2D group communication concept has been described in WO2015/163798 A1, WO2016/128847 A1, and WO2017/182068 A1.

The 2-hop group transmission concept is described in FIG. 1. When one UE in the group wants to transmit data through the group, it sends its data over the sidelink to the other users in the group, see left hand side of FIG. 1. Thereafter (2nd hop) the data is sent in a synchronized manner from the UEs in the group over the cellular UL to the network node (eNB/gNB), see right hand side of FIG. 1.

FIG. 1 is a schematic overview of the 2-hop group communication from previous patents WO2015/163798 A1, WO2016/128847 A1, and WO2017/182068 A1. One UE (“originating” UE) wants to transmit data through the group to e/gNB.

In the DL, the network transmits data to the group as if it were a single UE. At least one UE in the group must be able to receive the DL data. If necessary, the DL data is relayed to the other UEs in the group via D2D.

This is not an entirely new technique and is also known as cooperative relaying or Virtual Antenna Array. However, D2D group communication extends this further by introducing a complete method for how to do this in a cellular communication network. With the introduction of the group identity (ID) concept, there is no need for an extra radio chain. Furthermore, the UEs in the group are not required to have UL coverage; only one of the UEs in the group must have UL/DL cellular coverage.

In NR, UL transmissions are done according to a spatial relation. This relation is initiated during the random access procedure via the synchronization signal block (SSB) selection, i.e., the UE indicates a preferable DL beam which has an reference signal received power (RSRP) above a threshold. The following UL and DL transmissions follow this spatial relation.

There exists support for some parts needed for cooperative transmissions to some extent in 3GPP. It is for example possible to create groups of UEs transmitting to each other using the 3GPP release (Rel.) 12 LTE concept proximity-based services (ProSe). Also, in NR Rel 16 there is support for D2D transmissions over Sidelink (SL) and to configure groups that share SL resources.

### SideLink in NR.

Sidelink transmissions over NR are specified in Rel. 16. Four new enhancements are particularly introduced to NR sidelink transmissions as follows:

Not only broadcast but also unicast and groupcast are supported in sidelink transmissions. For unicast and groupcast, the physical sidelink feedback channel (PSFCH) is introduced for a receiving UE to reply decoding status to a transmitting UE.

To improve the latency performance, grant-free transmissions that are adopted in NR uplink transmissions are also provided in NR sidelink transmissions.

To alleviate resource collisions among different sidelink transmissions launched by different UEs, NR sidelink enhances channel sensing and resource selection procedures, which also lead to a new design of Physical Sidelink Control Channel (PSCCH).

Added quality of service (QOS) management, including congestion control, makes it possible to achieve a high connection density of devices using NR sidelink transmissions.

To enable the above enhancements, new physical channels and reference signals are introduced in NR, available in LTE before:

Physical Sidelink Shared Channel (PSSCH), which is an SL version of PDSCH: The PSSCH is transmitted by a sidelink transmitting UE, which conveys sidelink transmission data, system information blocks (SIB) for radio resource control (RRC) configuration, and a part of sidelink control information (SCI).

PSFCH, which is an SL version of PUCCH: The PSFCH is transmitted by a sidelink receiving UE for unicast and groupcast, which conveys 1 bit information over 1 resource block (RB) for the hybrid automatic repeat request (HARQ) acknowledgement (ACK) and the negative ACK (NACK). In addition, channel state information (CSI) is carried in the medium access control (MAC) control element (CE) over the PSSCH instead of the PSFCH.

Physical Sidelink Common Control Channel (PSCCH), which is an SL version of PDCCH: When the traffic to be sent to a receiving UE arrives at a transmitting UE, a transmitting UE should first send the PSCCH, which conveys a part of SCI (Sidelink Control information, SL version of DCI) to be decoded by any UE for the channel sensing purpose, including the reserved time-frequency resources for transmissions, demodulation reference signal (DMRS) pattern and antenna port, etc.

Sidelink Primary Synchronization Signal (SPSS) and Sidelink Secondary Synchronization Signal (SSSS): Similar to downlink transmissions in NR, in sidelink transmissions, primary and secondary synchronization signals (called SPSS and SSSS, respectively) are supported. Through detecting the SPSS and SSSS, a UE is able to identify the sidelink synchronization identity (SSID) from the UE sending the SPSS/SSSS. Through detecting the SPSS/SSSS, a UE is therefore able to know the characteristics of the UE transmitting the SPSS/SSSS. A series of process of acquiring timing and frequency synchronization together with SSIDs of UEs is called initial cell search. Note that the UE sending the SPSS/SSSS may not be necessarily involved in sidelink transmissions, and a node (UE/eNB/gNB) sending the SPSS/SSSS is called a synchronization source.

Physical Sidelink Broadcast Channel (PSBCH): The PSBCH is transmitted along with the SPSS/SSSS as a synchronization signal/PSBCH block (SSB). The SSB has the same numerology as PSCCH/PSSCH on that carrier, and an SSB should be transmitted within the bandwidth of the configured BWP. The PSBCH conveys information related to synchronization, such as the direct frame number (DFN), indication of the slot and symbol level time resources for sidelink transmissions, in-coverage indicator, etc. The SSB is transmitted periodically at every 160 ms.

DMRS, phase tracking reference signal (PT-RS), channel state information reference signal (CSI-RS): These physical reference signals supported by NR downlink/uplink transmissions are also adopted by sidelink transmissions. Similarly, the PT-RS is only applicable for frequency range 2 (FR2) transmission.

Another new feature is the two-stage sidelink control information (SCI). This a version of the DCI for SL. Unlike the DCI, only part, for example, a first stage, of the SCI is sent on the PSCCH. This part is used for channel sensing purposes, including the reserved time-frequency resources for transmissions, DMRS pattern and antenna port, etc., and can be read by all UEs while the remaining, for example, a second stage, scheduling and control information such as a 8-bits source identity (ID) and a 16-bits destination ID, new data indicator (NDI), redundancy version (RV), and HARQ process ID is sent on the PSSCH to be decoded by the receiving UE.

Similar as for PROSE in LTE, NR sidelink transmissions have the following two modes of resource allocations:

Mode 1: Sidelink resources are scheduled by a gNB.

Mode 2: The UE autonomously selects sidelink resources from a (pre-) configured sidelink resource pool(s) based on the channel sensing mechanism.

For the in-coverage UE, a gNB can be configured to adopt Mode 1 or Mode 2. For the out-of-coverage UE, only Mode 2 can be adopted.

As in LTE, scheduling over the sidelink in NR is done in different ways for Mode 1 and Mode 2.

Mode 1 supports the following two kinds of grants:

Dynamic grant: When the traffic, to be sent over sidelink, arrives at a transmitting UE, this UE should launch the four-message exchange procedure to request sidelink resources from a gNB, scheduling request (SR) on UL, grant, buffer status report (BSR) on UL, grant for data on SL sent to UE. During the resource request procedure, a gNB may allocate a sidelink radio network temporary identifier (SL-RNTI) to the transmitting UE, during random access (RA). If this sidelink resource request is granted by a gNB, then a gNB indicates the resource allocation for the PSCCH and the PSSCH in the downlink control information (DCI) conveyed by PDCCH with CRC scrambled with the SL-RNTI. When a transmitting UE receives such a DCI, a transmitting UE can obtain the grant only if the scrambled CRC of DCI can be successfully solved by the assigned SL-RNTI. A transmitting UE then indicates the time-frequency resources and the transmission scheme of the allocated PSSCH in the PSCCH and launches the PSCCH and the PSSCH on the allocated resources for sidelink transmissions. When a grant is obtained from a gNB, a transmitting UE can only transmit a single transport block (TB). As a result, this kind of grant is suitable for traffic with a loose latency requirement.

Configured grant: For the traffic with a strict latency requirement, performing the four-message exchange procedure to request sidelink resources may induce unacceptable latency. In this case, prior to the traffic arrival, a transmitting UE may perform the four-message exchange procedure and request a set of resources. If a grant can be obtained from a gNB, then the requested resources are reserved in a periodic manner. Upon traffic arriving at a transmitting UE, this UE can launch the PSCCH and the PSSCH on the upcoming resource occasion. In fact, this kind of grant is also known as grant-free transmissions.

Both dynamic and configured grants are addressed to the transmitting UE, and therefore a sidelink receiving UE cannot receive the DCI. Instead, a receiving UE should perform blind decoding to identify the presence of PSCCH and find the resources for the PSSCH through the SCI.

The SCI has a first and second part. The first part, sent on PSCCH, comprises reserved time-frequency resources for transmissions, demodulation reference signal (DMRS) pattern and antenna port, etc., and the second part, sent on PSSCH, comprises an 8-bits source identity (ID) and a 16-bits destination ID. SCI also includes a 1-bit new data indicator (NDI), 2-bit redundancy version (RV), and 4-bit HARQ process ID.

When a transmitting UE launches the PSCCH, cyclic redundancy check (CRC) is also inserted in the SCI without any scrambling.

In the Mode 2 resource allocation, when traffic arrives at a transmitting UE, this transmitting UE should autonomously select resources for the PSCCH and the PSSCH. To further minimize the latency of the feedback HARQ ACK/NACK transmissions and subsequently retransmissions, a transmitting UE may also reserve resources for PSCCH/PSSCH for retransmissions. To further enhance the probability of successful TB decoding at one shot and thus suppress the probability to perform retransmissions, a transmitting UE may repeat the TB transmission along with the initial TB transmission.

This mechanism is also known as blind retransmission. As a result, when traffic arrives at a transmitting UE, then this transmitting UE may select resources for the following transmissions:

1) The PSSCH associated with the PSCCH for initial transmission and blind retransmissions.

2) The PSSCH associated with the PSCCH for retransmissions.

Since each transmitting UE in sidelink transmissions should autonomously select resources for the above transmissions, preventing different transmitting UEs from selecting the same resources turns out to be a critical issue in Mode 2. A particular resource selection procedure is therefore imposed to Mode 2 based on channel sensing. The channel sensing algorithm involves measuring RSRP on different subchannels and requires knowledge of the different UEs power levels of DMRS on the PSSCH or the DMRS on the PSCCH depending on the configuration. This information is known only after receiving SCI launched by (all) other UEs. The sensing and selection algorithm is rather complex.

4 step RA procedure in NR.

A 4-step approach is used for the legacy random-access procedure, see FIG. 2. In this approach, the UE detects synchronization signals (SS) and decodes the broadcasted system information, followed by transmitting a physical random access channel (PRACH) preamble (message 1) in the uplink. The gNB replies with a Random Access Response (RAR) or message 2. The UE then transmits a UE identification (message 3) on PUSCH using an uplink grant, i.e., allocation of uplink transmission resources.

The UE transmits message 3, on PUSCH, after receiving a timing advance command in the RAR, allowing PUSCH to be received with a timing accuracy within the cyclic prefix (CP). Without this timing advance, a very large CP would be needed in order to be able to demodulate and detect PUSCH, unless the system is applied in a cell with very small distance between UE and gNB. Since NR will also support larger cells with a need for providing a timing advance to the UE, the 4-step approach is needed for random access procedure. To complete the RA procedure, the gNb sends message 4, which contains the contention resolution id. The UE can from the contention resolution id see that the UE has been correctly identified. Thus, FIG. 2 shows a 4-step random access procedure.

### Indication of SSB.

In Rel-15 the UE will indicate an SSB with a preamble transmission. The purpose of this is to let the gNB know which transmission beam to use for the transmission of the RAR and subsequent messages. It is also used to let the gNb choose an adequate reception beam. The SSB selection by the UE is done by comparing the SS-RSRP to the rsrp-ThresholdSSB. For the contention based Random Access the selection is done as follows (from (38.321)
1> else (i.e., for the contention-based Random Access preamble selection):
   2> if at least one of the SSBs with SS-RSRP above rsrp-ThresholdSSB is available:
      3>select an SSB with SS-RSRP above rsrp-ThresholdSSB.
   2> else:
      3>select any SSB.

Once the SSB has been selected, the indication to the gNB is done by selection of preamble and/or RACH occasion (RO) depending on the configuration. The configuration states whether the UE should choose preamble and/or RO. With the use of specific preambles and/or RO, the UE implicitly indicates the selected SSB to the gNB.

In one extreme configuration, the indication is done purely by the preamble meaning that the preamble index will indicate the SSB irrespective of in which RO it is transmitted. On the other extreme, the RO alone will indicate the SSB, irrespective of preamble index. In a typical case the indication will be a combination of these extremes: depending on which RO, the preamble index will indicate the SSB meaning that a certain preamble index will indicate different SSBs depending on in which RO it is transmitted.

The available number of SSBs (up to 64) will impact the configuration of resources and it can be observed that for a high number of available SSBs, indicating using only preamble ID is not sufficient, since preamble IDs will be needed also for contention free RA and SI requests. When several ROs are needed to indicate SSB, the latency of the RA procedure will increase latency, alternatively give a large overhead in terms of configured ROs. Hence, when the number of available SSBs is high, preambles and ROs will be a scarce resource and the RA configuration will have to balance the overhead in terms of PRACH resources with the latency and allocation of preambles to other things than SSB indication.

2-step RA procedure was specified in 3GPP Rel-16. With the 2-step procedure the random access is completed in only two steps as illustrated in FIG. 3.

Step 1: The UE sends a message A including a random access preamble together with higher layer data such as RRC connection request possibly with some small payload on PUSCH, denoted “msgA PUSCH”. The msgA PUSCH can be used for small data transmissions in inactive, Rel. 17 work item (WI).

Step 2: The gNB sends a response called message B, which may be described as a modified RAR, including UE identifier assignment, timing advance information, and contention resolution message etc. In addition, message B (msgB) may contain a higher layer part. Similar to a RAR, a msgB may contain responses to multiple msgAs, and thus to multiple UEs, but the optional higher layer part can only pertain to one of the responses, i.e., to one of the msgAs/UEs. If a response in a msgB does not have an associated higher layer part, this will be sent in a separate subsequent message, e.g., an RRC message, on the PDSCH. Thus, FIG. 3 shows a two-step initial access procedure.

The msgB is a response to msgA, which may contain contention resolution message(s), fallback indication(s) to schedule Msg3 transmission, and backoff indication.

The msgB is a response to msgA, which may contain responses to multiple UEs and with different kinds of information for different UEs depending on the outcome of the msgA transmission/reception, and the load on the access resources.

Upon a successful msgA reception, the gNB includes a successRAR MAC subPDU as a response for the concerned UE, where the successRAR MAC subPDU includes a contention resolution identity, a timing advance and a cell (C)-RNTI allocation. If the gNB successfully received the RACH preamble, but failed to receive msgA PUSCH, the gNB can respond to the concerned UE with a fallbackRAR MAC subPDU in the msgB. The fallbackRAR essentially turns the 2-step RA into a 4-step RA and consequently the fallbackRAR MAC subPDU contains an UL grant, a timing advance and a temporary C-RNTI (TC-RNTI) allocation, but no contention resolution identity. The UE uses the UL grant to retransmit msgA PUSCH in the form of Msg3.

In the same way as for the 4-step procedure, the SSB is indicated with the preamble transmission, either via the preamble index or the Rach occasion where the preamble transmission.

### SUMMARY

As part of developing embodiments here one or more problems were first identified. A UE, for example, a NR UE, will establish a spatial relation to the gNB during the Random Access procedure. Also, in case of cooperative transmissions in NR, the spatial relation of the group of UEs with respect to the gNB needs to be established. That is, the SSB that best serves the group, i.e., provides the largest gain when performing cooperative transmissions, needs to be determined. Gain can be measured in terms of, e.g., coverage or power consumption. Note that this would typically not be an SSB, which is optimal for every single UE in the group. There is currently no method to determine the best SSB for a group of UEs since in the legacy RA procedure it is done on a per UE basis, and the spatial relation for cooperative transmissions should be from the group of UEs to the gNb, and vice versa. During legacy random access, the SSB of the UE doing the random access will be indicated but this may not be optimal for the group, considering that the group may contain UEs which have different preferred SSBs. If each UE in the group would perform individual Random Access procedures without coordination, as in legacy, the gNB would not be able to derive which SSB and hence which transmission and reception beam that is optimal for the cooperative group transmissions. This may result in a reduced or limited performance of the wireless communications network.

An object herein is to provide a mechanism to improve performance of the wireless communications network.

According to an aspect the object is achieved, according to embodiments herein, by providing a method performed by a coordinating UE for handling a cooperative transmission of data from a group of UEs in a wireless communications network. The coordinating UE obtains one or more indications from one or more UEs of the group of UEs, wherein each indication indicates a preferred SSB for respective UE. The coordinating UE selects an SSB for a random access procedure for the group of UEs performing the cooperative transmission based on the obtained one or more indications. The coordinating UE further transmits an SSB indication to the group of UEs indicating the selected SSB; and performs the random access procedure to a radio network node based on the selected SSB.

According to another aspect the object is achieved, according to embodiments herein, by providing a method performed by a UE, also referred to as a group UE, for handling a cooperative transmission of data from a group of UEs comprising a coordinating UE in a wireless communications network. The UE transmits an indication to the coordinating UE, wherein the indication indicates a preferred SSB, for the UE. The UE receives from the coordinating UE, an SSB indication indicating a selected SSB for a random access procedure for the group of UEs performing the cooperative transmission; and performs the random access procedure based on the indicated selected SSB.

According to yet another aspect the object is achieved, according to embodiments herein, by providing a method performed by a radio network node for handling a cooperative transmission of data from a group of UEs in a wireless communications network for handling cooperative transmissions of data from a group of UEs in a wireless communications network. The radio network node configures dedicated resources related to a random access procedure for the group of UEs. The radio network node receives indications from one or more UEs of the group of UEs, wherein each indication indicates a preferred SSB, for respective UE. The radio network node selects a SSB for the random access procedure for the group of UEs performing the cooperative transmission; and transmits a response to the one or more UEs of the group of UEs using the selected SSB.

According to yet still another aspect the object is achieved, according to embodiments herein, by providing a method performed by a UE, also referred to as group UE, for handling a cooperative transmission of data from a group of UEs in a wireless communications network. The UE receives configuration data, from a radio network node, indicating dedicated resources related to a random access procedure for the group of UEs. The UE selects a preferred SSB for the random access procedure, and transmits an indication to the radio network node, wherein the indication indicates the selected preferred SSB for the UE. The UE further monitors for the dedicated resources related to the random access procedure; and receives a response from the radio network node related to one of the dedicated resources, thus, indicating the SSB to use.

According to an aspect the object is achieved, according to embodiments herein, by providing a radio network node and UEs configured to perform the methods, respectively.

Thus, it is herein provided a coordinating UE for handling a cooperative transmission of data from a group of UEs in a wireless communications network. The coordinating UE is configured to obtain one or more indications from one or more UEs of the group of UEs, wherein each indication indicates a preferred SSB for respective UE. The coordinating UE is further configured to select an SSB for a random access procedure for the group of UEs performing the cooperative transmission based on the obtained one or more indications. The coordinating UE is also configured to transmit an SSB indication to the group of UEs indicating the selected SSB; and to perform the random access procedure to a radio network node based on the selected SSB.

Furthermore, it is herein provided a UE for handling a cooperative transmission of data from a group of UEs comprising a coordinating UE in a wireless communications network. The UE is configured to transmit an indication to the coordinating UE, wherein the indication indicates a preferred SSB, for the UE. The UE is further configured to receive from the coordinating UE, an SSB indication indicating a selected SSB for a random access procedure for the group of UEs performing the cooperative transmission; and configured to perform the random access procedure based on the indicated selected SSB.

It is also herein provided a radio network node for handling a cooperative transmission of data from a group of UEs in a wireless communications network for handling cooperative transmissions of data from a group of UEs in a wireless communications network. The radio network node is configured to configure dedicated resources related to a random access procedure for the group of UEs. The radio network node is configured to receive indications from one or more UEs of the group of UEs, wherein each indication indicates a preferred SSB, for respective UE. The radio network node is further configured to select a SSB for the random access procedure for the group of UEs performing the cooperative transmission; and to transmit a response to the one or more UEs of the group of UEs using the selected SSB.

In addition, it is herein provided a UE for a cooperative transmission of data from a group of UEs in a wireless communications network. The UE is configured to receive configuration data, from a radio network node, indicating dedicated resources related to a random access procedure for the group of UEs. The UE is further configured to select a preferred SSB for the random access procedure, and transmits an indication to the radio network node, wherein the indication indicates the selected preferred SSB for the UE. The UE is configured to monitor for the dedicated resources related to the random access procedure; and to receive a response from the radio network node related to one of the dedicated resources, thus, indicating the SSB to use.

It is furthermore provided herein a computer program product comprising instructions, which, when executed on at least one processor, cause the at least one processor to carry out the methods above, as performed by the radio network node or UEs, respectively. It is additionally provided herein a computer-readable storage medium, having stored thereon a computer program product comprising instructions which, when executed on at least one processor, cause the at least one processor to carry out the methods above, as performed by the UEs or radio network node, respectively.

Embodiments herein disclose a solution that can determine an SSB to use for a group of UEs doing cooperative transmissions. This may be done by the UEs in the group reporting their preferred SSB to a coordinating UE which processes the information and determines which SSB is optimal. This SSB is indicated when doing random access for the group, i.e., for cooperative UL transmissions from the group. Alternatively, each UE selects an SSB and indicates this via the preamble transmission. The radio network node receiving the preamble transmissions may then determine which SSB is optimal and replies to this preamble transmission. Embodiments herein enable a selection of SSB which is optimal for cooperative transmissions from a group of UEs. Thus, embodiments herein provide a solution resulting in improved performance of the wireless communications network.

### BRIEF DESCRIPTION OF THE DRAWINGS

Embodiments will now be described in more detail in relation to the enclosed drawings, in which:

FIG. 1 illustrates prior art;

FIG. 2 illustrates a 4-step RACH process according to prior art;

FIG. 3 illustrates a 2-step RACH process according to prior art;

FIG. 4 shows a wireless communications network illustrating embodiments herein;

FIG. 5a shows a combined flowchart and signalling scheme according to embodiments herein;

FIG. 5b shows a combined flowchart and signalling scheme according to embodiments herein;

FIG. 6 shows a flowchart depicting a method performed by a coordinating UE according to embodiments herein;

FIG. 7 shows a flowchart depicting a method performed by a UE according to embodiments herein;

FIG. 8 shows a flowchart depicting a method performed by a radio network node according to embodiments herein;

FIG. 9 shows a flowchart depicting a method performed by a UE according to embodiments herein;

FIG. 10 shows a block diagram depicting coordinating UEs according to embodiments herein;

FIG. 11 shows a block diagram depicting UEs according to embodiments herein;

FIG. 12 shows a block diagram depicting radio network nodes according to embodiments herein;

FIG. 13 shows a block diagram depicting UEs according to embodiments herein;

FIG. 14 schematically illustrates a telecommunication network connected via an intermediate network to a host computer;

FIG. 15 is a generalized block diagram of a host computer communicating via a base station with a user equipment over a partially wireless connection; and

FIGS. 16-19 are flowcharts illustrating methods implemented in a communication system including a host computer, a base station and a user equipment.

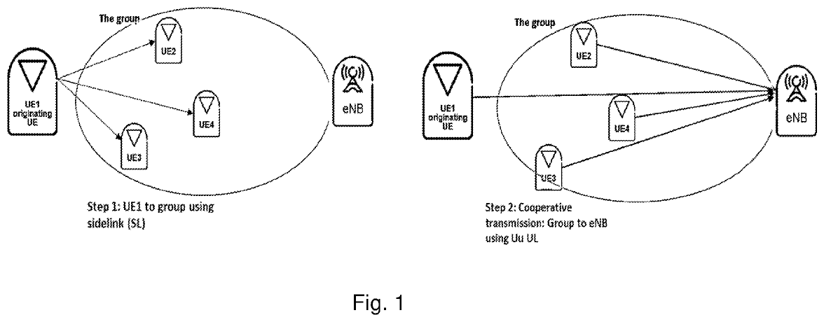

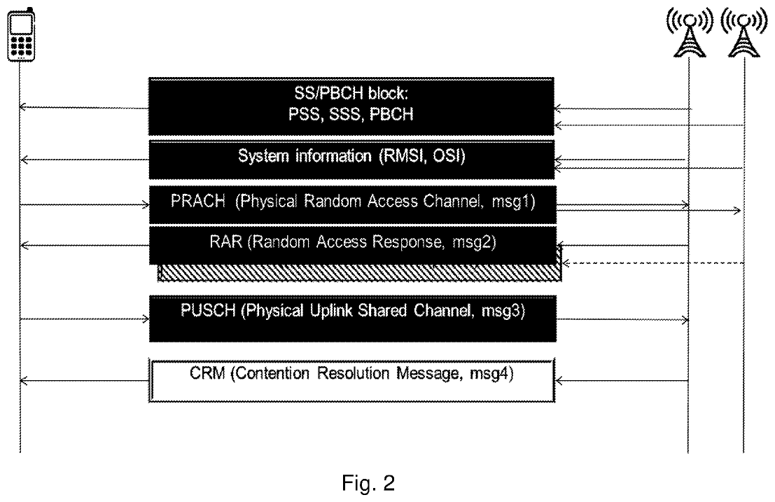

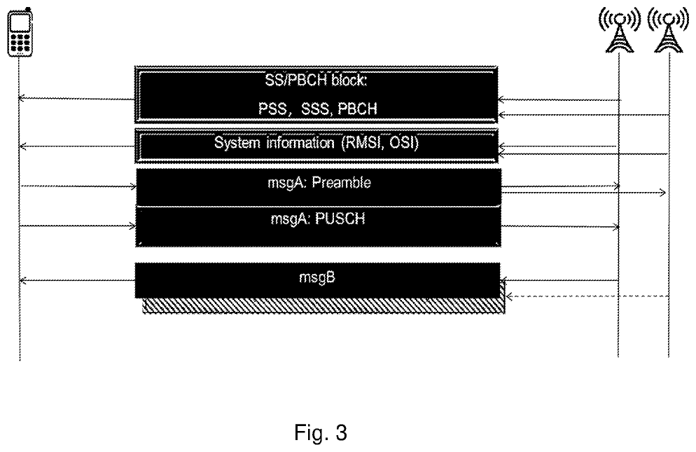

### DETAILED DESCRIPTION

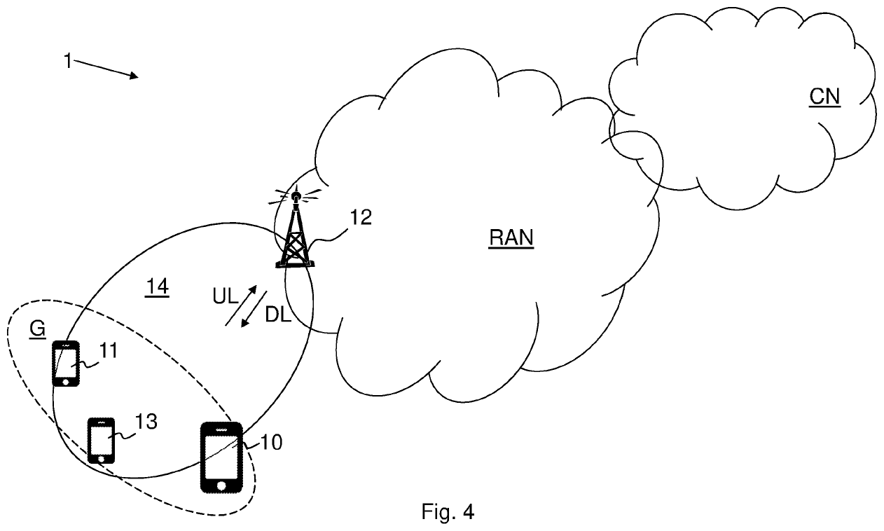

Embodiments herein relate to wireless communications networks in general. FIG. 4 is a schematic overview depicting a wireless communications network 1. The wireless communications network 1 comprises one or more RANs and one or more CNs. The wireless communications network 1 may use one or a number of different technologies. Embodiments herein relate to recent technology trends that are of particular interest in a New Radio (NR) context, however, embodiments are also applicable in further development of existing wireless communications systems such as e.g. LTE or Wideband Code Division Multiple Access (WCDMA).

In the wireless communications network 1, a user equipment (UE) 10 exemplified herein as a wireless device such as a mobile station, a non-access point (non-AP) station (STA), a STA and/or a wireless terminal, is comprised communicating via e.g. one or more Access Networks (AN), e.g. radio access network (RAN), to one or more core networks (CN). It should be understood by the skilled in the art that “UE” is a non-limiting term which means any terminal, wireless communications terminal, user equipment, narrowband internet of things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node. The UE 10 is performing cooperative transmissions of data with a group of UEs G, illustrated herein as UE 11 and UE 13, or UE2 and UE3. The UE 10 is denoted as a coordinating UE 10 for coordinating the cooperative transmission and the other UEs of the group may be denoted as group UEs. The group of UEs may be determined and configured from the coordinating UE 10 based on, e.g., proximity, negotiation or similar.

The wireless communications network 1 comprises a radio network node 12 providing radio coverage over a geographical area, a first service area 14 or first cell, of a first radio access technology (RAT), such as NR, LTE, or similar. The radio network node 12 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the radio network node depending e.g. on the first radio access technology and terminology used. The radio network node may be referred to as a serving radio network node wherein the service area may be referred to as a serving cell, and the serving network node communicates with the wireless device in form of DL transmissions to the wireless device and UL transmissions from the wireless device. It should be noted that a service area may be denoted as cell, beam, beam group or similar to define an area of radio coverage. Herein it is provided methods that enable a selection of SSB which is optimal for cooperative transmissions from a group of UEs. In the embodiments described herein the group of UEs may be in RRC_IDLE or RRC_INACTIVE mode. One UE, such as the coordinating UE 10 in the group may have data to send. Thus, a connection setup or connection resume may be initiated with RA. One or more UEs of the group of UEs may be located so that individual radio conditions are poor. However, by utilizing cooperative transmissions UL data transmission may be performed in an efficient manner. An alternative scenario is when the UEs are in RRC_CONNECTED mode and some UE receives data for UL cooperative transmissions but there is no UL grant and the group has no scheduling request (SR) configuration and therefore needs to perform a random access procedure. Embodiments herein provide solutions how to coordinate a SSB for the group of UEs performing cooperative transmissions in an efficient manner.

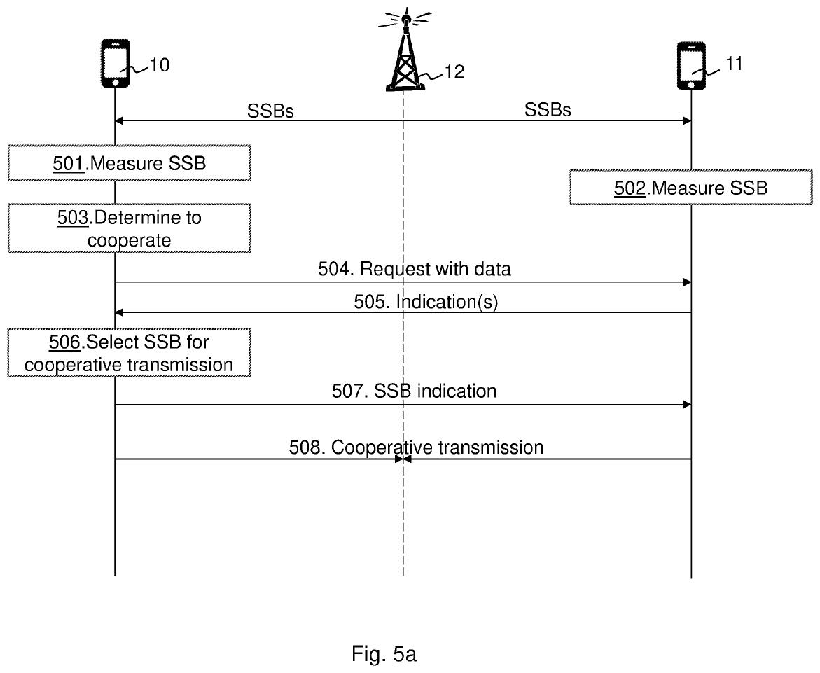

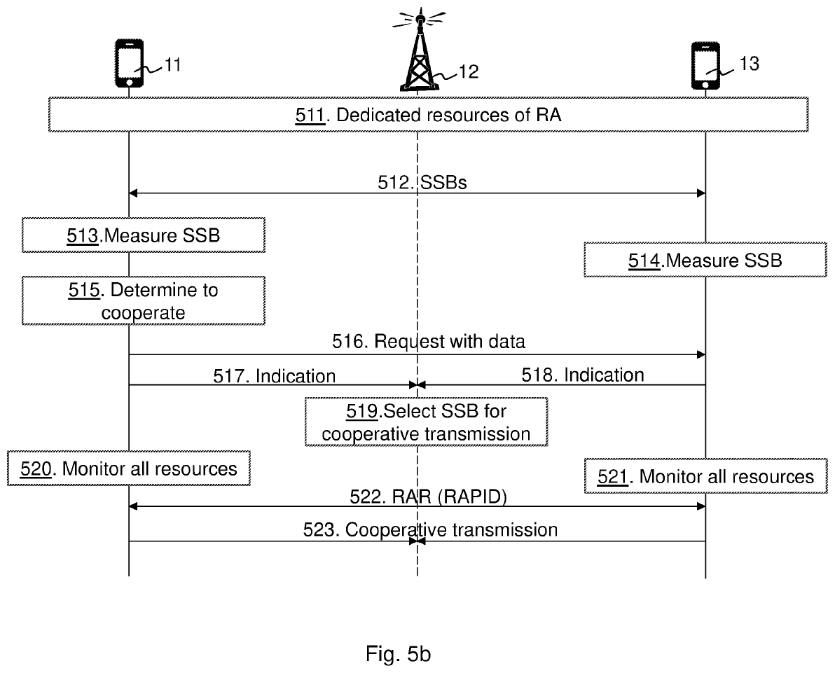

FIG. 5a is a combined flowchart and signalling scheme depicting embodiments herein. The radio network node transmits one or more SSBs in the cell of the radio network node.

Action 501. The coordinating UE 10 may perform measurements on all SSBs known to the coordinating UE 10. For example, the coordinating UE 10 may measure synchronization signal reference signal received power (SS-RSRP) for each SSB.

Action 502. The group UE UE2 may also perform measurements, e.g., SS-RSRP, on all SSBs known to the group UE2.

Action 503. The coordinating UE 10 that has data to send may determine to perform a cooperative transmission. For example, the coordinating UE 10 may, based on poor radio conditions, determine to use a cooperative transmission to increase the throughput of the transmission.

Action 504. The coordinating UE 10 sends a request to the group for performing a cooperative transmission. Thus, the coordinating UE 10 may send data to all UEs in the group. The UEs in group are RRC_Idle but UEs may still be active on the SL.

Action 505. The group UE2, or all UEs in the group, transmits an indication that indicates a preferred SSB for respective UE. The indication may indicate the measurements of one or more SSB.

Action 506. The coordinating UE 10 receives one or more indications of preferred SSBs, and selects an SSB for a RA procedure for the group of UEs performing the cooperative transmission based on the obtained one or more indications. The coordinating may select the SSB that has the best average signal strength or quality or similar.

Action 507. The coordinating UE 10 then transmits an SSB indication to the group of UEs indicating the selected SSB. The coordinating UE 10 may for example send an index or other indication indicating the selected SSB.

Action 508. The coordinating UE 10 and the group UE2, then initiates the cooperative transmission by performing the random access procedure to the radio network node 12 based on the selected SSB. For example, the coordinating UE 10 and the group UE2 transmits a preamble of the selected SSB.

FIG. 5b is a combined flowchart and signalling scheme depicting alternative embodiments herein. The radio network node transmits one or more SSBs in the cell of the radio network node.

Action 511. The radio network node 12 may configure dedicated resources for RA in the group of UEs. For example, the radio network node 12 may dedicate certain preambles for the group of UEs. For example, the group of UE may have been allocated a set of preambles mapping to the different SSBs. The mapping may contain an RO to SSB mapping.

Action 512. The radio network node transmits SSBs in the cell.

Action 513. The group UE 11 may measure SS-RSRP of the SSBs configured in the cell and may select SSB.

Action 514. The group UE 13 may measure SS-RSRP of the SSBs configured in the cell and may select SSB.

Action 515. The group UE 11 may determine to perform a cooperative transmission for data.

Action 516. The group UE 11 may then transmit a request with the data for cooperative transmission.

Action 517. The group UE 11 indicates selected SSB, for example, transmit preamble configured for the selected SSB, possibly taking into account the RO to SSB mapping.

Action 518. The group UE 11 indicates selected SSB. Note, this may lead to that different UEs in the group transmit different preambles on different ROs.

Action 519. The radio network node 12 selects SSB for cooperative transmission. Thus, the radio network node 12 may monitor for preamble transmissions from the group. If several preambles are received from the group of UEs, the radio network node 12 may select which preamble to respond to.

Action 520. The group UE 11 monitors all dedicated resources. E.g., monitoring for RAPID configured at the group UE 11.

Action 521. The group UE 11 monitors all dedicated resources. E.g., monitoring for RAPID configured at the group UE 11.

Action 522. The sends Random Access Responses (RAR) indicating the selected SSB by using the preamble id, such as a random access preamble ID (RAPID), corresponding to the selected SSB.

Action 523. The group of UEs may then perform a cooperative transmission based on the RAR.

An advantage of these embodiments is that the radio network node 12 may choose to select an SSB, by responding to this preamble, which has a lower load. Since all the UEs transmit with the same power the selection at the radio network node 12, based on its received power, gives a good indication of the best SSB of the group.

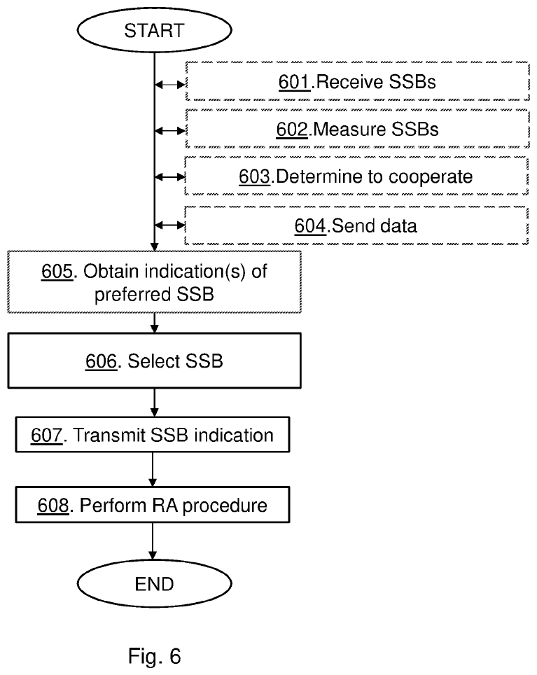

The method actions performed by the coordinating UE 10 for handling a cooperative transmission of data from a group of UEs in the wireless communications network according to embodiments will now be described with reference to a flowchart depicted in FIG. 6. The actions do not have to be taken in the order stated below, but may be taken in any suitable order. Dashed boxes indicate optional features.

Action 601. The coordinating UE 10 may receive a number of SSBs from the radio network node 12.

Action 602. The coordinating UE 10 may measure a signal strength or quality of one or more SSBs configured in a cell of the radio network node 12. The coordinating UE 10 may measure, prior to the transmission of data for cooperative transmission when the group is Idle or inactive, SS-RSRP of the SSBs configured in the cell. The SSBs can include or be limited to SSBs configured for 2-step random access; The SSBs can include or be limited to SSBs configured for 4-step random access; The SSBs can include a combination of the SSBs configured for 2-step random access and the SSBs configured for 4-step random access.

Action 603. The coordinating UE 10 determines to perform a cooperative transmission.

Action 604. The coordinating UE 10 may transmit data, to one or more UEs in the group of UEs, for the cooperative transmission.

Action 605. The coordinating UE 10 obtains one or more indications from one or more UEs of the group of UEs, wherein each indication indicates a preferred SSB for respective UE. The UE may receive and/or also measure internally SSBs. The obtained one or more indications may comprise one or more measurement reports with one or more SSB signal strengths or qualities. The measurement report may comprise one or more of the following: SS-RSRPs of all measured SSBs; only the SSB with the highest SS-RSRP; only the SSBs with SS-RSRP above a threshold. The threshold may be the ordinary threshold for SSB selection, e.g., rsrp-ThresholdSSB or a different threshold. In case of 2-step random access, the msgA may include measurement reports of the SS-RSRP of the different SSBs. The reported measurement may be aggregated, e.g., mean SS-RSRP per beam, or SS-RSRP per UE per beam. Only measurements above a threshold may be reported.

Action 606. The coordinating UE 10 selects an SSB for a random access procedure for the group of UEs performing the cooperative transmission based on the obtained one or more indications. The coordinating UE 10 may select the SSB by evaluating the measured signal strength or quality and/or the received one or more measurement reports and by selecting the SSB based on the evaluation. The selected SSB may be:
the SSB which is overall best determined as
i. A weighted average of the reported SS-RSRP reported from the different UEs of the different SSBs
ii. A weighted average of the reported SS-RSRP of the different SSBs for a subset of UEs in the group.
   1. The subset of UEs could be determined based on the SL radio conditions to the coordinator UE. A UE with good SL radio conditions will have a high weight in the averaging.
   2. The subset of UEs could be determined based on the UL radio conditions of the UE reporting the SS-RSRP. A UE with good UL radio conditions will have a high weight in the averaging.
   3. The subset of UEs could be determined based on a combination of the above two selection criteria.
any, e.g., randomly selected, SSB with SS-RSRP over a threshold. The SS-RSRP could be of a single UE, e.g. the coordinating UE 10, or be a weighted average of the SS-RSRP reported by the UEs in the group.
The SSB which has the best lowest SS-RSRP among the UEs in the group. The selection is given by Max_{SSB}{Min_{UE}(SS-RSRP)}, i.e., for each SSB, the SS-RSRP of the UE that has the worst SS-RSRP are compared as selection criteria.

Thus, the coordinating UE 10 may process received signal strengths or qualities and may decide on which SSB is best for cooperative transmissions from the group of UEs.

Action 607. The coordinating UE 10 may transmit the SSB indication to the group of UEs indicating the selected SSB. The coordinating UE 10 may transmit the SSB indication to the group of UEs by transmitting an indication of a selected preamble and/or a random access channel occasion. The coordinating UE 10 may need to consider the time that is needed to transmit this information to the other UEs into account when selecting RO, meaning that it might not be the first available RO indicating the selected SSB that is selected.

Action 608. The coordinating UE 10 performs the random access procedure to the radio network node 12 based on the selected SSB. The coordinating UE 10 may perform the random access procedure by selecting a preamble and/or a random access channel occasion for random access to indicate the selected SSB to the radio network node. For example, the coordinating UE 10 may select preamble and RO to indicate the selected SSB to the radio network node 12.

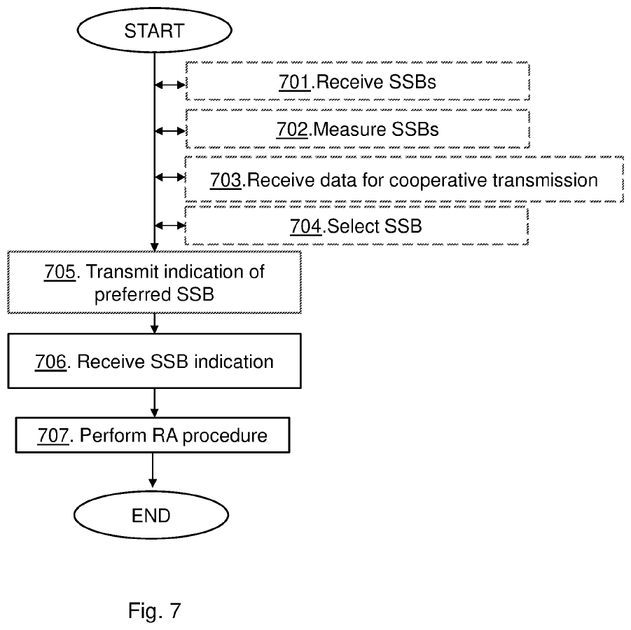

The method actions performed by the group UE 11, referred to as the UE, for handling the cooperative transmission of data from the group of UEs comprising a coordinating UE in a wireless communications network according to embodiments will now be described with reference to a flowchart depicted in FIG. 7. The actions do not have to be taken in the order stated below, but may be taken in any suitable order. Dashed boxes indicate optional features.

Action 701. The group UE 11 may receive a number of SSBs from the radio network node 12.

Action 702. The group UE 11 may measure a signal strength or quality of one or more SSBs configured in a cell of the radio network node 12. The group UE 11 may measure, prior to the reception of data for cooperative transmission when the group is Idle or inactive, SS-RSRP of the SSBs configured in the cell. The SSBs can include or be limited to SSBs configured for 2-step random access; The SSBs can include or be limited to SSBs configured for 4-step random access; The SSBs can include a combination of the SSBs configured for 2-step random access and the SSBs configured for 4-step random access.

Action 703. The group UE 11 may receive data, from the coordinating UE 10, for the cooperative transmission.

Action 704. The group UE 11 may select SSB based on the measured signal strength or quality.

Action 705. The group UE 11 transmits an indication to the coordinating UE 10, wherein the indication indicates the preferred SSB for the group UE 11. The transmitted indication may comprise one or more measurement reports with one or more SSB signal strengths or qualities. The measurement report can be configured to
i. Include SS-RSRPs of all measured SSBs
ii. Include only the SSB with the highest SS-RSRP
iii. Include only the SSBs with SS-RSRP above a threshold

The threshold may be the ordinary threshold for SSB selection, e.g. rsrp-ThresholdSSB or a different threshold.

In case of 2-step random access, the msgA may include measurement reports of the SS-RSRP of the different SSBs. The reported measurement may be aggregated, e.g., mean SS-RSRP per beam, or SS-RSRP per UE per beam. Only measurements above a threshold may be reported.

Action 706. The group UE 11 further receives from the coordinating UE 10, the SSB indication indicating the selected SSB for the random access procedure for the group of UEs performing the cooperative transmission. The group UE 11 may receive the SSB indication from the coordinating UE 10, by receiving the indication of the selected preamble and/or the random access channel occasion, and by using the indicated preamble and/or the random access channel occasion when performing the random access procedure. Thus, informing the group UE 11 of the selected preamble and RO when to transmit the preamble.

Action 707. The group UE 11 performs the random access procedure based on the indicated selected SSB.

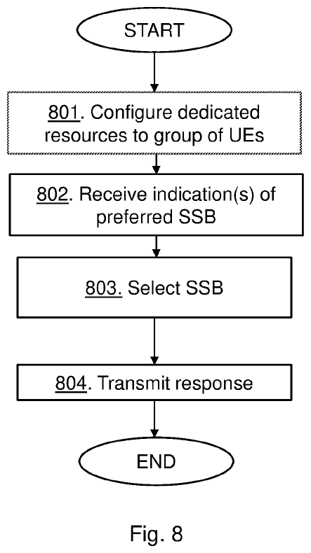

The method actions performed by the radio network node 12 for handling a cooperative transmission of data from the group of UEs in a wireless communications network according to embodiments will now be described with reference to a flowchart depicted in FIG. 8. The actions do not have to be taken in the order stated below but may be taken in any suitable order. Dashed boxes indicate optional features. This alternative embodiment is suitable in case of contention free random access where the group of UEs has been allocated a set of preambles and/or ROs mapping to the different SSBs.

Action 801. The radio network node 12 configures dedicated resources related to a random access procedure for the group of UEs. The dedicated resources may comprise preambles and/or ROs. For example, in case of contention free random access the group of UEs has been allocated a set of preambles mapping to the different SSBs. Also in this case, the mapping may contain an RO to SSB mapping.

Action 802. The radio network node 12 receives indications from one or more UEs of the group of UEs, wherein each indication indicates a preferred SSB for respective UE.

Action 803. The radio network node 12 selects a SSB for the random access procedure for the group of UEs performing the cooperative transmission. In action 802, the radio network node 12 may receive the indications by monitoring for preambles from the one or more UEs, and the radio network node 12 may then select the SSB by selecting a preamble to respond to based on signal strength/quality and/or load on SSBs. For example, the radio network node 12 may monitor for preamble transmissions from the group of UEs. If several preambles are received from the group of UEs, the radio network node 12 may select which preamble to respond to based on:
a. received power or quality of preamble transmission. For example, SSB corresponding to preamble with highest received power is selected.
b. load on different SSBs. If preambles corresponding to several SSBs received, the SSB with lowest load is selected.
c. Combination of the above two selection criteria.

It should here be noted that the radio network node 12 may monitor for the preambles during a time interval set by a timer. The radio network node 12 may monitor for preambles during a time length long enough for UEs selecting different SSB to have a RO to transmit their preambles, if different SSBs correspond to different ROs. A timer may be defined for this.

Action 804. The radio network node 12 transmits a response to the one or more UEs of the group of UEs using the selected SSB. The transmitted response may comprise a RAR indicating the selected SSB by using a preamble identity, for example, RAPID, corresponding to the selected SSB.

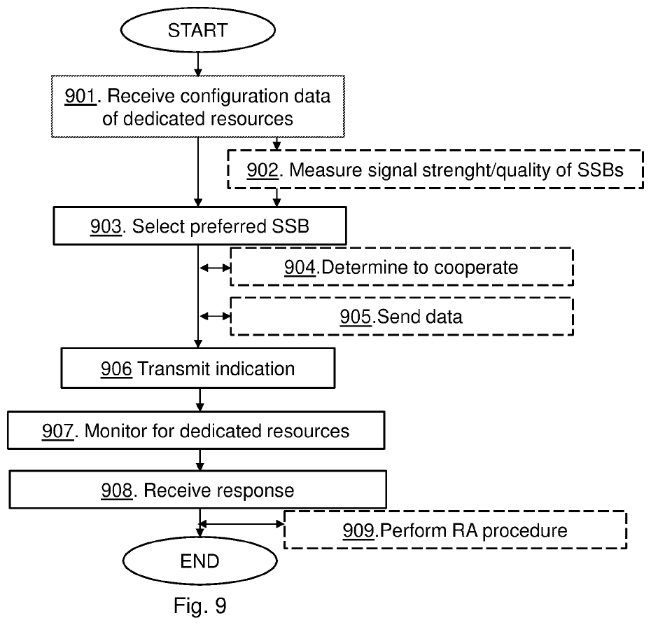

The method actions performed by the group UE 11 for handling a cooperative transmission of data from the group of UEs in the wireless communications network according to embodiments will now be described with reference to a flowchart depicted in FIG. 9. The actions do not have to be taken in the order stated below, but may be taken in any suitable order. Dashed boxes indicate optional features.

Action 901. The group UE 11 receives configuration data, from the radio network node 12, indicating dedicated resources related to a random access procedure for the group of UEs.

Action 902. The group UE 11 may measure a signal strength or quality of one or more SSBs configured in a cell of the radio network node 12.

Action 903. The group UE 11 selects a preferred SSB for the random access procedure. The preferred SSB may be selected based on the measured signal strength or quality. Prior to transmission of data for cooperative Tx when the group is RRC_Idle or Inactive (or the group has no UL grant and no SR resources), the UEs may measure SS-RSRP of the SSBs configured in the cell and select SSB according to legacy (Rel. 15 and/or Rel. 16) procedures.

Action 904. The group UE 11 may determine to perform a cooperative transmission.

Action 905. The group UE 11 may send data, to UEs in the group of UEs, for the cooperative transmission. A group UE that has data to send, may thus send sends data to all UEs in the group.

Action 906. The group UE 11 transmits an indication to the radio network node 12, wherein the indication indicates the selected preferred SSB for the UE. For example, the group UE 11 may transmit a preamble and/or at a random access channel occasion configured for the selected preferred SSB. The UEs transmit preambles configured for SSBs, possibly taking into account the RO to SSB mapping. Note, this may lead to that different UEs in the group of UE may transmit different preambles on different ROs.

Action 907. The group UE 11 monitors for the dedicated resources related to the random access procedure. For example, the group UE 11 may monitor for random access responses indicating respective preamble identity corresponding to respective configured SSB. Thus, all UEs in the group may monitor for RARs indicating any of the configured RAPIDs, since the SSB selected by gNB may not be the same as the individual UE selected.

Action 908. The group UE 11 receives a response from the radio network node related to one of the dedicated resources.

Action 909. The group UE 11 may then perform a cooperative transmission using the SSB related to the one dedicated resource.

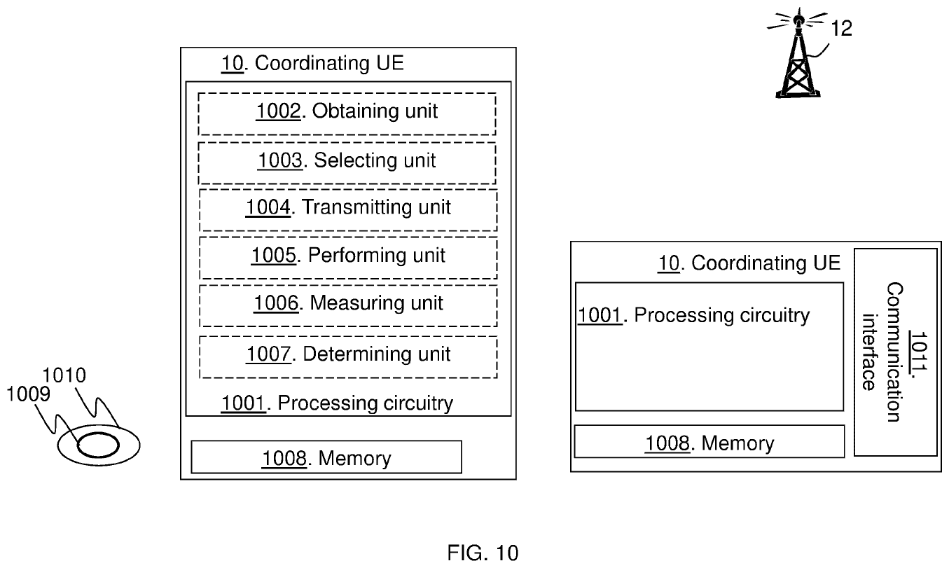

FIG. 10 is a block diagram depicting the coordinating UE 10 for handling a cooperative transmission of data from the group of UEs in the wireless communications network 1 according to embodiments herein.

The coordinating UE 10 may comprise processing circuitry 1001, e.g. one or more processors, configured to perform the methods herein.

The coordinating UE 10 may comprise an obtaining unit 1002, e.g. a reader, a receiver or a transceiver. The coordinating UE 10, the processing circuitry 1001, and/or the obtaining unit 1002 is configured to obtain the one or more indications from one or more UEs of the group of UEs, wherein each indication indicates the preferred SSB for respective UE. The obtained one or more indications may comprise one or more measurement reports with one or more SSB signal strengths or qualities.

The coordinating UE 10 may comprise a selecting unit 1003. The coordinating UE 10, the processing circuitry 1001, and/or the selecting unit 1003 is configured to select an SSB for the random access procedure for the group of UEs performing the cooperative transmission based on the obtained one or more indications. The coordinating UE 10, the processing circuitry 1001, and/or the selecting unit 1003 may be configured to select the SSB by evaluating the measured signal strength, quality and/or the received one or more measurement reports and selecting the SSB based on the evaluation.

The coordinating UE 10 may comprise a transmitting unit 1004, e.g., a transmitter or a transceiver. The coordinating UE 10, the processing circuitry 1001, and/or the transmitting unit 1004 is configured to transmit the SSB indication to the group of UEs indicating the selected SSB.

The coordinating UE 10 may comprise a performing unit 1005. The coordinating UE 10, the processing circuitry 1001, and/or the performing unit 1005 is configured to perform the random access procedure to the radio network node 12 based on the selected SSB. The coordinating UE 10, the processing circuitry 1001, and/or the performing unit 1005 may be configured to perform the random access procedure by selecting a preamble and/or a random access channel occasion for random access to indicate the selected SSB to the radio network node. The coordinating UE 10, the processing circuitry 1001, and/or the transmitting unit 1004 may be configured to transmit the SSB indication to the group of UEs by transmitting the indication of the selected preamble and/or the random access channel occasion.

The coordinating UE 10 may comprise a measuring unit 1006. The coordinating UE 10, the processing circuitry 1001, and/or the measuring unit 1006 may be configured to measure the signal strength or quality of the one or more SSBs configured in the cell of the radio network node 12.

The coordinating UE 10 may comprise a determining unit 1007. The coordinating UE 10, the processing circuitry 1001, and/or the determining unit 1007 may be configured to determine to perform the cooperative transmission.

The coordinating UE 10, the processing circuitry 1001, and/or the transmitting unit 1004 may be configured to send data, to the UEs in the group of UEs, for the cooperative transmission.

The coordinating UE 10 further comprises a memory 1008. The memory comprises one or more units to be used to store data on, such as indications, thresholds, data, group information, strengths or qualities, SSBs, preambles, RO information, UL grants, requests, timers, applications to perform the methods disclosed herein when being executed, and similar. Thus, embodiments herein may disclose a coordinating UE for handling a cooperative transmission of data from the group of UEs in the wireless communications network, wherein the coordinating UE comprises processing circuitry and a memory, said memory comprising instructions executable by said processing circuitry whereby coordinating said UE is operative to perform any of the methods herein. The UE comprises a communication interface 1011 comprising, e.g., a transmitter, a receiver, a transceiver and/or one or more antennas.

The methods according to the embodiments described herein for the coordinating UE 10 are respectively implemented by means of, e.g., a computer program product 1009 or a computer program, comprising instructions, i.e., software code portions, which, when executed on at least one processor, cause the at least one processor to carry out the actions described herein, as performed by the coordinating UE 10. The computer program product 1009 may be stored on a computer-readable storage medium 1010, e.g., a universal serial bus (USB) stick, a disc or similar. The computer-readable storage medium 1010, having stored thereon the computer program product, may comprise the instructions which, when executed on at least one processor, cause the at least one processor to carry out the actions described herein, as performed by the coordinating UE 10. In some embodiments, the computer-readable storage medium may be a non-transitory or a transitory computer-readable storage medium.

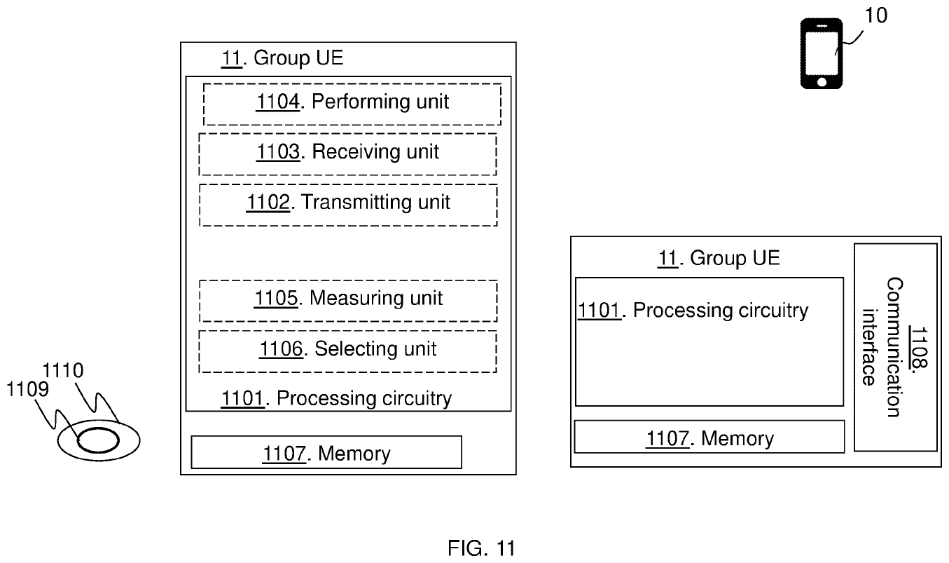

FIG. 11 is a block diagram depicting the group UE 11 for handling a cooperative transmission of data from the group of UEs comprising the coordinating UE in the wireless communications network 1 according to embodiments herein.

The group UE 11 may comprise processing circuitry 1101, e.g. one or more processors, configured to perform the methods herein.

The group UE 11 may comprise a transmitting unit 1102, e.g. a transmitter or a transceiver. The group UE 11, the processing circuitry 1101, and/or the transmitting unit 1102 is configured to transmit the indication to the coordinating UE 10, wherein the indication indicates the preferred SSB for the UE 11. The transmitted indication comprises one or more measurement reports with one or more SSB signal strengths or qualities.

The group UE 11 may comprise a receiving unit 1103, e.g. a receiver or a transceiver. The group UE 11, the processing circuitry 1101, and/or the receiving unit 1103 is configured to receive from the coordinating UE 10, the SSB indication indicating the selected SSB for the random access procedure for the group of UEs performing the cooperative transmission.

The group UE 11 may comprise a performing unit 1104. The group UE 11, the processing circuitry 1101, and/or the performing unit 1104 is configured to perform the random access procedure based on the indicated selected SSB. The group UE 11, the processing circuitry 1101, and/or the receiving unit 1103 may be configured to receive the SSB indication from the coordinating UE 10, by receiving the indication of the selected preamble and/or the random access channel occasion. The group UE 11, the processing circuitry 1101, and/or the performing unit 1104 may be configured to use the indicated preamble and/or the random access channel occasion when performing the random access procedure.

The group UE 11, the processing circuitry 1101, and/or the receiving unit 1103 may be configured to receive a number of SSBs from the radio network node 12.

The group UE 11 may comprise a measuring unit 1105. The group UE 11, the processing circuitry 1101, and/or the measuring unit 1105 may be configured to measure the signal strength or quality of one or more SSBs configured in the cell of the radio network node 12. For example, measure, prior to the reception of data for cooperative transmission when the group is Idle or inactive, SS-RSRP of the SSBs configured in the cell. The SSBs can include or be limited to SSBs configured for 2-step random access; The SSBs can include or be limited to SSBs configured for 4-step random access; The SSBs can include a combination of the SSBs configured for 2-step random access and the SSBs configured for 4-step random access.

The group UE 11 may comprise a selecting unit 1106. The group UE 11, the processing circuitry 1101, and/or the selecting unit 1106 may be configured to select SSB based on the measured signal strength or quality.

The group UE 11, the processing circuitry 1101, and/or the receiving unit 1103 may be configured to receive data, from the coordinating UE 10, for the cooperative transmission.

The group UE 11 further comprises a memory 1107. The memory comprises one or more units to be used to store data on, such as indications, thresholds, data, group information, strengths or qualities, SSBs, preambles, RO information, UL grants, requests, timers, applications to perform the methods disclosed herein when being executed, and similar. Thus, embodiments herein may disclose a group UE 11 for handling a cooperative transmission of data from the group of UEs comprising the coordinating UE in the wireless communications network, wherein the group UE 11 comprises processing circuitry and a memory, said memory comprising instructions executable by said processing circuitry whereby coordinating said group UE is operative to perform any of the methods herein. The group UE 11 comprises a communication interface 1108 comprising, e.g., a transmitter, a receiver, a transceiver and/or one or more antennas.

The methods according to the embodiments described herein for the group UE 11 are respectively implemented by means of, e.g., a computer program product 1109 or a computer program, comprising instructions, i.e., software code portions, which, when executed on at least one processor, cause the at least one processor to carry out the actions described herein, as performed by the group UE 11. The computer program product 1109 may be stored on a computer-readable storage medium 1110, e.g., a universal serial bus (USB) stick, a disc or similar. The computer-readable storage medium 1110, having stored thereon the computer program product, may comprise the instructions which, when executed on at least one processor, cause the at least one processor to carry out the actions described herein, as performed by the group UE 11. In some embodiments, the computer-readable storage medium may be a non-transitory or a transitory computer-readable storage medium.

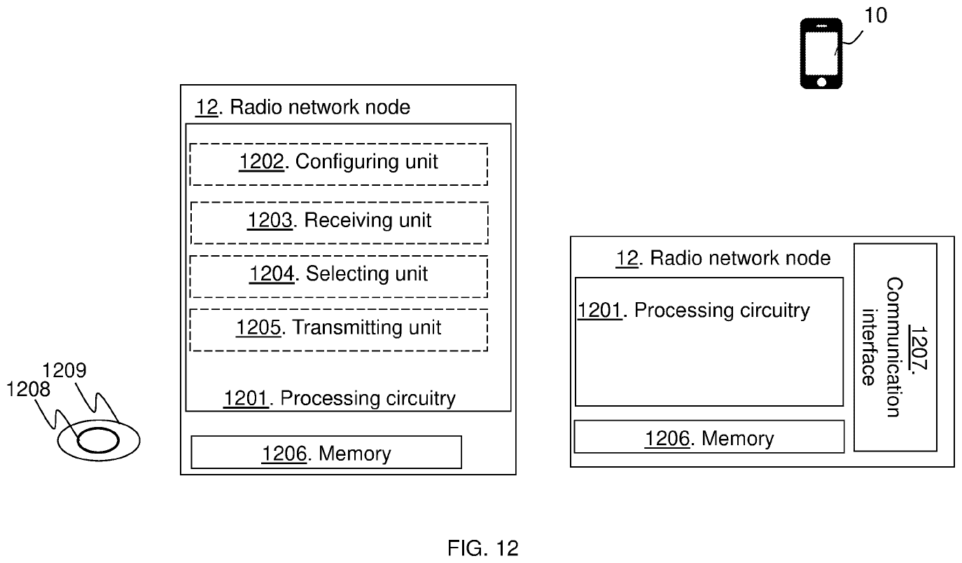

FIG. 12 is a block diagram depicting the radio network node 12 for handling a cooperative transmission of data from the group of UEs in the wireless communications network 1 according to embodiments herein.

The radio network node 12 may comprise processing circuitry 1201, e.g. one or more processors, configured to perform the methods herein.

The radio network node 12 may comprise a configuring unit 1202. The radio network node 12, the processing circuitry 1201, and/or the configuring unit 1202 is configured to configure dedicated resources related to a random access procedure for the group of UEs.

The radio network node 12 may comprise a receiving unit 1203, e.g. a receiver or a transceiver. The radio network node 12, the processing circuitry 1201, and/or the receiving unit 1203 is configured to receive the indications from one or more UEs of the group of UEs, wherein each indication indicates the preferred SSB, for respective UE. The radio network node 12 may comprise a selecting unit 1204. The radio network node 12, the processing circuitry 1201, and/or the selecting unit 1204 is configured to select the SSB for the random access procedure for the group of UEs performing the cooperative transmission.

The radio network node 12 may comprise a transmitting unit 1205, e.g. a transmitter or a transceiver. The radio network node 12, the processing circuitry 1201, and/or the transmitting unit 1205 is configured to transmit the response to the one or more UEs of the group of UEs using the selected SSB.

The radio network node 12, the processing circuitry 1201, and/or the receiving unit 1203 may be configured to receive the indications by monitoring for preambles from the one or more UEs, and the radio network node 12, the processing circuitry 1201, and/or the selecting unit 1204 may be configured to select the SSB by selecting a preamble to respond to based on signal strength, quality and/or load on SSBs. The radio network node 12, the processing circuitry 1201, and/or the receiving unit 1203 may be configured monitor for the preambles during the time interval set by the timer.

The radio network node 12, the processing circuitry 1201, and/or the transmitting unit 1205 may be configured to transmit the random access response indicating the selected SSB by using the preamble identity corresponding to the selected SSB.

The radio network node 12 further comprises a memory 1206. The memory comprises one or more units to be used to store data on, such as indications, thresholds, data, group information, strengths or qualities, SSBs, preambles, RO information, UL grants, requests, timers, applications to perform the methods disclosed herein when being executed, and similar. Thus, embodiments herein may disclose a radio network node for handling a cooperative transmission of data from the group of UEs in the wireless communications network, wherein the radio network node comprises processing circuitry and a memory, said memory comprising instructions executable by said processing circuitry whereby coordinating said radio network node is operative to perform any of the methods herein. The radio network node 12 comprises a communication interface 1207 comprising, e.g., a transmitter, a receiver, a transceiver and/or one or more antennas.

The methods according to the embodiments described herein for the radio network node 12 are respectively implemented by means of, e.g., a computer program product 1208 or a computer program, comprising instructions, i.e., software code portions, which, when executed on at least one processor, cause the at least one processor to carry out the actions described herein, as performed by the radio network node 12. The computer program product 1208 may be stored on a computer-readable storage medium 1209, e.g., a universal serial bus (USB) stick, a disc or similar. The computer-readable storage medium 1209, having stored thereon the computer program product, may comprise the instructions which, when executed on at least one processor, cause the at least one processor to carry out the actions described herein, as performed by the radio network node 12. In some embodiments, the computer-readable storage medium may be a non-transitory or a transitory computer-readable storage medium.

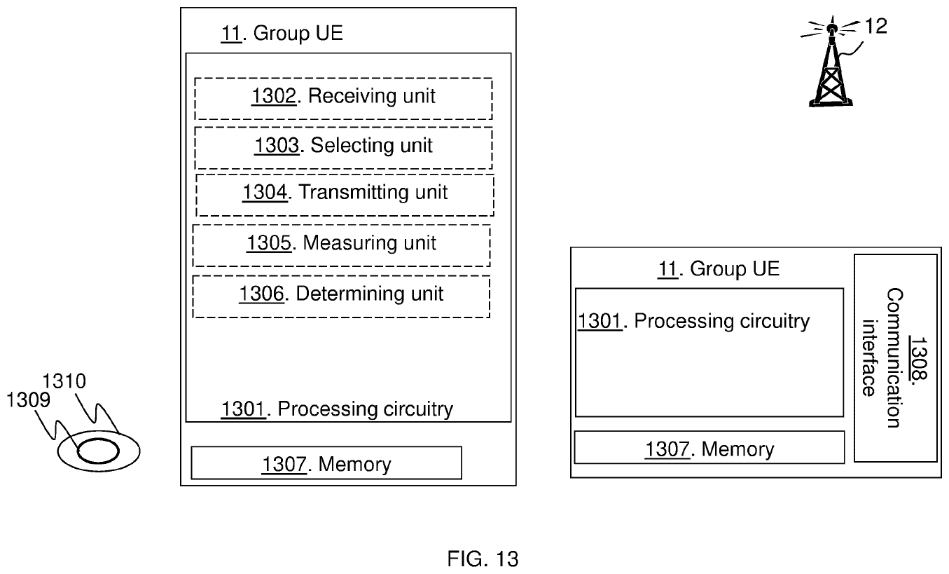

FIG. 13 is a block diagram depicting the group UE 11 for handling the cooperative transmission of data from the group of UEs in the wireless communications network 1 according to embodiments herein.

The group UE 11 may comprise processing circuitry 1301, e.g. one or more processors, configured to perform the methods herein.

The group UE 11 may comprise a receiving unit 1302, e.g. a receiver or a transceiver. The group UE 11, the processing circuitry 1301, and/or the receiving unit 1302 is configured to receive configuration data, from the radio network node, indicating dedicated resources related to the random access procedure for the group of UEs.

The group UE 11 may comprise a selecting unit 1303. The group UE 11, the processing circuitry 1301, and/or the selecting unit 1303 is configured to select the preferred SSB for the random access procedure.

The group UE 11 may comprise a transmitting unit 1304, e.g., a transmitter or a transceiver. The group UE 11, the processing circuitry 1301, and/or the transmitting unit 1304 is configured to transmit the indication to the radio network node, wherein the indication indicates the selected preferred SSB for the UE.

The group UE 11, the processing circuitry 1301, and/or the receiving unit 1302 is configured to monitor for the dedicated resources related to the random access procedure; and to receive the response from the radio network node 12 related to one of the dedicated resources. The group UE 11, the processing circuitry 1301, and/or the receiving unit 1302 may be configured to monitor for random access responses indicating respective preamble identity, e.g., RAPID, corresponding to respective configured SSB.

The group UE 11, the processing circuitry 1301, and/or the transmitting unit 1304 may be configured to transmit the indication by transmitting the preamble and/or at a random access channel occasion configured for the selected preferred SSB.

The group UE 11 may comprise a measuring unit 1305. The group UE 11, the processing circuitry 1301, and/or the measuring unit 1305 may be configured measure the signal strength or quality of one or more SSBs configured in the cell of the radio network node 12; and wherein the preferred SSB is selected based on the measured signal strength or quality.

The group UE 11 may comprise a determining unit 1306. The group UE 11, the processing circuitry 1301, and/or the determining unit 1306 may be configured to determine to perform the cooperative transmission.

The group UE 11, the processing circuitry 1301, and/or the transmitting unit 1304 may be configured to send data, to UEs in the group of UEs, for the cooperative transmission.

The group UE 11 further comprises a memory 1307. The memory comprises one or more units to be used to store data on, such as indications, thresholds, data, group information, strengths or qualities, SSBs, preambles, RO information, UL grants, requests, timers, applications to perform the methods disclosed herein when being executed, and similar. Thus, embodiments herein may disclose a group UE for handling a cooperative transmission of data from the group of UEs comprising the coordinating UE in the wireless communications network, wherein the group UE comprises processing circuitry and a memory, said memory comprising instructions executable by said processing circuitry whereby coordinating said group UE is operative to perform any of the methods herein. The group UE 11 comprises a communication interface 1308 comprising, e.g., a transmitter, a receiver, a transceiver and/or one or more antennas.

The methods according to the embodiments described herein for the group UE 11 are respectively implemented by means of, e.g., a computer program product 1309 or a computer program, comprising instructions, i.e., software code portions, which, when executed on at least one processor, cause the at least one processor to carry out the actions described herein, as performed by the group UE 11. The computer program product 1309 may be stored on a computer-readable storage medium 1310, e.g., a universal serial bus (USB) stick, a disc or similar. The computer-readable storage medium 1310, having stored thereon the computer program product, may comprise the instructions which, when executed on at least one processor, cause the at least one processor to carry out the actions described herein, as performed by the group UE 11. In some embodiments, the computer-readable storage medium may be a non-transitory or a transitory computer-readable storage medium.

In some embodiments a more general term “radio network node” is used and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, gNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

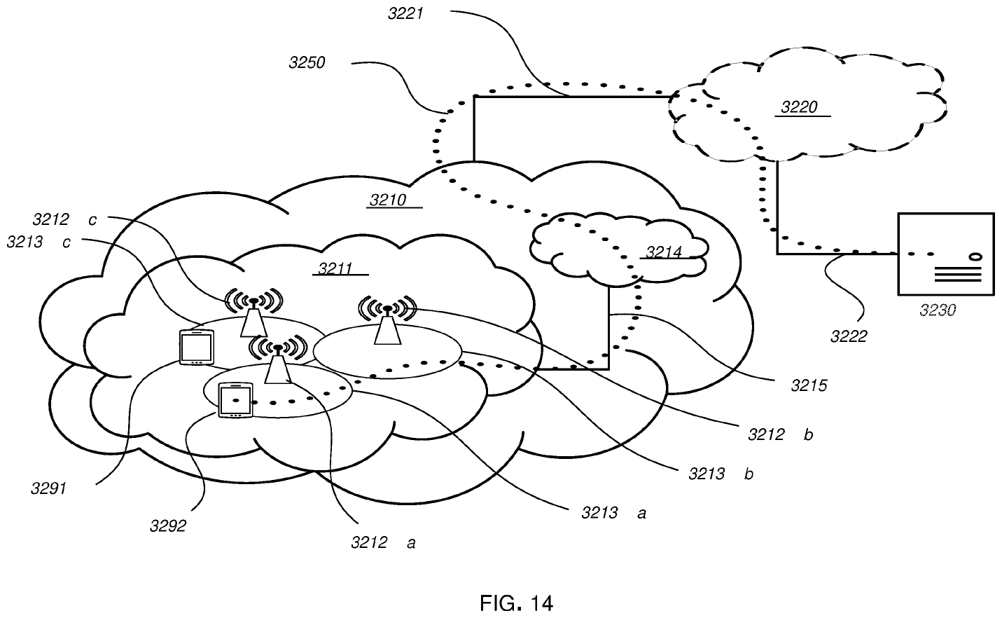

With reference to FIG. 14, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10 and relay UE 13, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 14 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

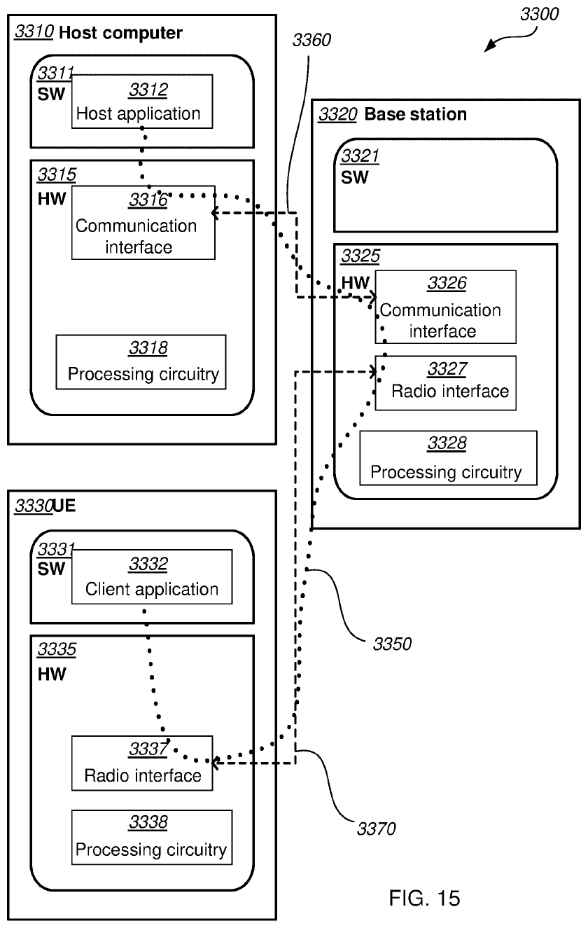

Example implementations, in accordance with an embodiment, of the UE, base station and host computer discussed in the preceding paragraphs will now be described with reference to FIG. 15. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 15) served by the base station 3320. The communication interface 3326 may be configured to facilitate a connection 3360 to the host computer 3310. The connection 3360 may be direct or it may pass through a core network (not shown in FIG. 15) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 15 may be identical to the host computer 3230, one of the base stations 3212a, 3212b, 3212c and one of the UEs 3291, 3292 of FIG. 14, respectively. This is to say, the inner workings of these entities may be as shown in FIG. 15 and independently, the surrounding network topology may be that of FIG. 14.

In FIG. 15, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance since grants are handled more accurate and thereby provide benefits such as reduced user waiting time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

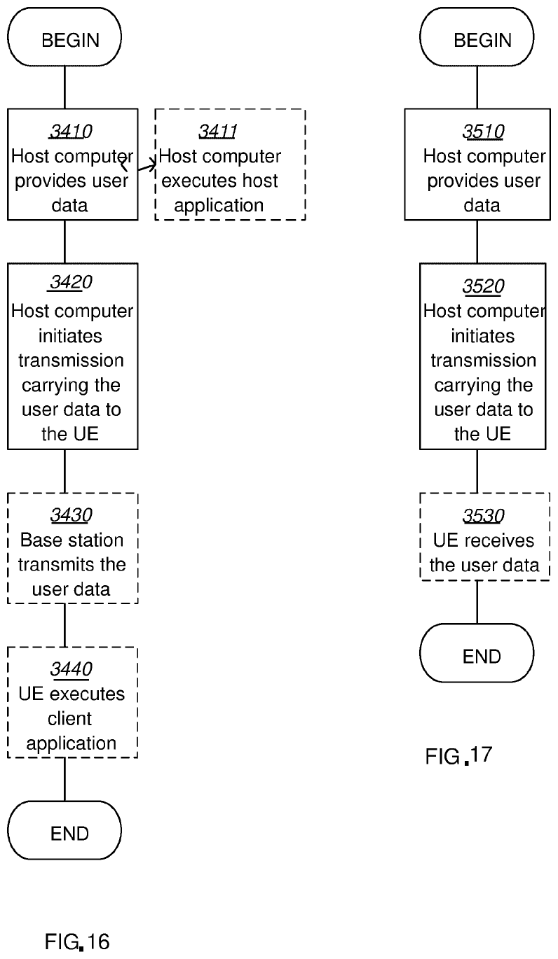

FIG. 16 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 16 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 17 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 17 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

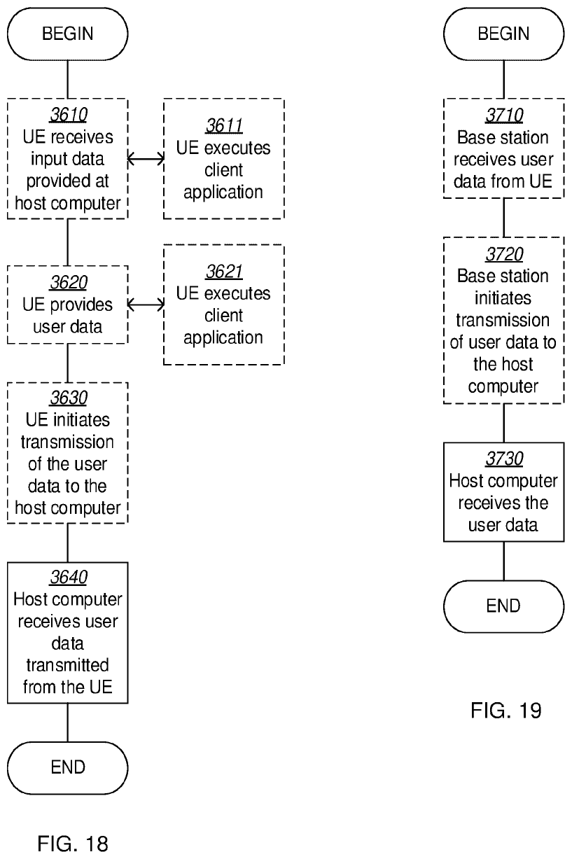

FIG. 18 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 18 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 19 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 19 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

### Abbreviation Explanation

3GPP 3rd Generation Partnership Project
BSR Buffer Status Report
BWP Bandwidth Part
CORESET Control Resource Set
CP Cyclic Prefix
CRM Contention Resolution Message
C-RNTI Cell RNTI
CSI Channel State Information
DC Dual Connectivity
DL Downlink
DMRS Demodulation Reference Signal
FFS For Further Study
gNB A radio base station in NR.
HARQ Hybrid Automatic Repeat reQuest
ID Identity/Identifier
IE Information Element
LAA License Assisted Access
LBT Listen-Before-Talk
LCG Logical Channel Group
LCH Logical Channel
LTE Long Term Evolution
MAC Medium Access Control
MAC CE MAC Control Element
Msg/msg Message
MU-MIMO Multi-User Multiple Input Multiple Output
NR New Radio
NR-U NR Unlicensed (NR operated in unlicensed spectrum.)
NW Network
OSI Other System Information
PBCH Physical Broadcast Channel
PDCCH Physical Downlink Control Channel
PDSCH Physical Downlink Shared Channel
PDU Protocol Data Unit
PO PUSCH Occasion
PRACH Physical Random Access Channel
PRB Physical Resource Block
PSS PUCCH Primary Synchronization Signal
PUCCH Physical Uplink Control Channel
PUSCH Physical Uplink Shared Channel
PUSCH PUSCH Resource Unit
RA Random Access
RACH Random Access Channel
RAN Radio Access Network
RAN1 A 3GPP technical specification working group.
RAN2 A 3GPP technical specification working group.
RAR Random Access Response
RAT Radio Access Technology
RMSI Remaining Minimum System Information
RNTI Radio Network Temporary Identifier
RO RACH Occasion
RRC Radio Resource Control
RSRP Reference Signal Received Power
RSRQ Reference Signal Received Quality
RTT Round-Trip Time
RU Resource Unit
SCS Subcarrier Spacing
SDU Service Data Unit
SFN System Frame Number
SIB System Information Block
SINR Signal to Interference and Noise Ratio
SNR Signal to Noise Ratio
SR Scheduling Request
SS Synchronization Signal
SSS Secondary Synchronization Signal
TR Technical Report
UE UL Uplink User Equipment
UL-SCH Uplink Shared Channel
URLLC Ultra-Reliable Low Latency Communication

1. A method performed by a coordinating user equipment, UE, for handling a cooperative transmission of data from a group of UEs in a wireless communications network, the method comprising:
obtaining one or more indications from one or more UEs of the group of UEs, wherein each indication indicates a preferred synchronization signal block, SSB, for respective UE;
selecting an SSB for a random access procedure for the group of UEs performing the cooperative transmission based on the obtained one or more indications;
transmitting an SSB indication to the group of UEs indicating the selected SSB; and
performing the random access procedure to a radio network node based on the selected SSB.

2. The method according to claim 1, wherein the performing the random access procedure comprise selecting a preamble and/or a random access channel occasion for random access to indicate the selected SSB to the radio network node.

3. The method according to claim 2, wherein transmitting the SSB indication to the group of UEs comprises transmitting indication of selected preamble and/or the random access channel occasion.

4. The method according to claim 1, further comprising
measuring a signal strength or quality of one or more SSBs configured in a cell of the radio network node.

5. The method according to claim 1, wherein the obtained one or more indications comprise one or more measurement reports with one or more SSB signal strengths or qualities.

6. The method according to claim 3, wherein selecting the SSB comprises evaluating the measured signal strength, quality and/or the received one or more measurement reports and selecting the SSB based on the evaluation.

7. The method according to claim 1, further comprising
determining to perform a cooperative transmission; and
sending data, to UEs in the group of UEs, for the cooperative transmission.

8. A method performed by a user equipment, UE, for handling a cooperative transmission of data from a group of UEs comprising a coordinating UE in a wireless communications network; the method comprising
transmitting an indication to the coordinating UE, wherein the indication indicates a preferred synchronization signal block, SSB, for the UE;
receiving from the coordinating UE, an SSB indication indicating a selected SSB for a random access procedure for the group of UEs performing the cooperative transmission; and
performing the random access procedure based on the indicated selected SSB.

9. The method according to claim 8, wherein receiving the SSB indication from the coordinating UE, comprises receiving an indication of a selected preamble and/or a random access channel occasion, and using the indicated preamble and/or the random access channel occasion when performing the random access procedure.

10. The method according to claim 8, wherein the transmitted indication comprises one or more measurement reports with one or more SSB signal strengths or qualities.

11. A method performed by a radio network node for handling a cooperative transmission of data from a group of user equipments, UE, in a wireless communications network, the method comprising
configurating dedicated resources related to a random access procedure for the group of UEs;
receiving indications from one or more UEs of the group of UEs, wherein each indication indicates a preferred synchronization signal block, SSB, for respective UE;
selecting a SSB for the random access procedure for the group of UEs performing the cooperative transmission; and
transmitting a response to the one or more UEs of the group of UEs using the selected SSB.

12. The method according to claim 11, wherein receiving the indications comprises monitoring for preambles from the one or more UEs, and selecting the SSB comprises selecting a preamble to respond to based on signal strength, quality and/or load on SSBs.

13. The method according to claim 12, wherein monitoring for the preambles is performed during a time interval set by a timer.

14. The method according to claim 11, wherein the transmitted response comprises a random access response indicating the selected SSB by using a preamble identity corresponding to the selected SSB.

15. A method performed by a user equipment, UE, for handling a cooperative transmission of data from a group of UEs in a wireless communications network; the method comprising
receiving configuration data, from a radio network node, indicating dedicated resources related to a random access procedure for the group of UEs;
selecting a preferred synchronization signal block, SSB, for the random access procedure;
transmitting an indication to the radio network node, wherein the indication indicates the selected preferred SSB for the UE;
monitoring for the dedicated resources related to the random access procedure; and
receiving a response from the radio network node related to one of the dedicated resources.

16. The method according to claim 15, wherein monitoring for the dedicated resources comprises monitoring for random access responses indicating respective preamble identity corresponding to respective configured SSB.

17. The method according to claim 15, wherein transmitting the indication comprises transmitting a preamble and/or at a random access channel occasion configured for the selected preferred SSB.

18. The method according to claim 15, further comprising
measuring a signal strength or quality of one or more SSBs configured in a cell of the radio network node; and wherein the preferred SSB is selected based on the measured signal strength or quality.

19. The method according to claim 15, further comprising
determining to perform a cooperative transmission; and
sending data, to UEs in the group of UEs, for the cooperative transmission.

20. (canceled)

21. (canceled)

22. A coordinating user equipment, UE, for handling a cooperative transmission of data from a group of UEs in a wireless communications network, wherein the coordinating UE is configured to:
obtain one or more indications from one or more UEs of the group of UEs, wherein each indication indicates a preferred synchronization signal block, SSB, for respective UE;
select an SSB for a random access procedure for the group of UEs performing the cooperative transmission based on the obtained one or more indications;
transmit an SSB indication to the group of UEs indicating the selected SSB; and
perform the random access procedure to a radio network node based on the selected SSB.

23. The coordinating UE according to claim 22, wherein the coordinating UE is configured to perform the random access procedure by selecting a preamble and/or a random access channel occasion for random access to indicate the selected SSB to the radio network node.

24. The coordinating UE according to claim 23, wherein the coordinating UE is configured to transmit the SSB indication to the group of UEs by transmitting an indication of selected preamble and/or the random access channel occasion.

25.-40. (canceled)
